(19) United States
(12) Patent Application Publication
(10) Pub. No.: US 2012/0149468 A1
(43) Pub. Date: Jun. 14, 2012

(54) MACHINE HANDLE ASSEMBLY

(76) Inventors: Maarten P. MENHEERE, Rotterdam (NL); Edwin ROODENBURG, Kurnpen (NL); Fred A. CASTILLO, Bartlett, IL (US)

(21) Appl. No.: 13/275,718

(22) Filed: Oct. 18, 2011

Related U.S. Application Data
(60) Provisional application No. 61/394,124, filed on Oct. 18, 2010.

(51) Int. Cl. A63F 9/24; G05G 1/04; B23P 17/04

(52) U.S. Cl. 463/37; 29/428; 74/523

(57) ABSTRACT

Machine handle assemblies are provided that can be attached to an external surface of a machine. The machine handle assembly includes a handle mechanism and may include a handle. An illumination assembly provides lighting effects from the machine handle assembly. The machine handle assembly does not require space within the machine, allowing room in the machine for other elements or allowing the machine to be more compact. A user interacts with the machine handle assembly to control aspects of the machine.

### BACKGROUND OF THE INVENTION

This present invention generally pertains to machine handle assemblies that comprise a base, a cover, a handle, a torsion assembly, a switch, and an illumination member for providing a user with an illuminated means of control. The handle assemblies, advantageously exhibiting a minimum number of components and can be completely assembled and mounted to the outside of a machine, allowing for more usable space within the machine.

### DESCRIPTION OF THE BACKGROUND ART

Machine handle assemblies have desired features such as a handle mechanism that allows a user to operate a machine, the handle mechanism having manufacturing flexibility and low cost. While machine handle assemblies are attractive, there are many aspects in which improvement is sought. For example, there is a desire to be able to assemble the complete machine handle assembly outside of the machine. There is also a desire to mount the entire handle assembly to an exterior surface of the machine housing, freeing up usable space within the machine There is a further desire to provide illumination effects from the handle assembly.

Prior art approaches require that a handle mechanism be mounted from the inside of a machine. Prior art approaches further require that the handle or lever arm be installed after the handle mechanism is installed.

With the present approach, it has been determined that various characteristics of prior art may have shortcomings such as these, and undesirable attributes, results or effects. The present approach recognizes and addresses matters such as these to provide enhancements not heretofore available. Overall, the present approach more fully meets the need to provide a machine handle assembly that can be completely assembled separate from the machine, that can be mounted on an external surface of the machine to free up space inside the machine, and that can provide illumination effects from the handle mechanism.

### SUMMARY OF THE INVENTION

An aspect or embodiment of the invention pertains to an improved machine handle assembly that comprises a handle mechanism that can be fully assembled separately from the machine that the handle mechanism is to be installed on. The handle mechanism includes a base, a cover, a torsion assembly and a switch. For example, the handle assembly can be assembled as a separate component, thereby eliminating the need to manufacture and/or assemble the handle assembly in conjunction with the corresponding machine.

In accordance with another aspect or embodiment, a machine handle assembly is mounted to an exterior surface of a machine, thereby eliminating the need to use space within the machine for portions of the handle assembly. The machine handle assembly can be secured to the outside of the machine without having to access the inside of the machine, for example. This frees up interior space in the machine for other components or functions. Alternatively, it allows the machine to be reduced in size.

In accordance with another aspect or embodiment, the machine handle assembly includes an illumination assembly. This allows for a variety of lighting effects to emanate from the handle assembly. For example, a white light emitting diode (LED) or a red-green-blue (RGB) LED can be programmed for special effects, for example.

At least one embodiment of the invention to provide a machine handle assembly including, a handle mechanism having a base assembly, a cover assembly, a torsion assembly, a switch assembly, and wherein the machine handle assembly is adapted to mount on the exterior of a machine. In an aspect of the invention, the machine handle assembly further includes a handle. In another aspect of the invention, the machine handle assembly further includes an illumination assembly.

In yet another aspect of the invention, the torsion assembly includes a shaft, a bearing, a spring, a stop plate, a spring collar, a spacer, a bearing spacer, a spring post and a spring pawl. In another aspect of the invention, the base assembly includes a base, a support bracket, a lock pin, a ratchet pin, a bumper bracket, a bumper and a retaining member. In still another aspect of the invention, the cover assembly includes a base cover, a center cover and an illumination member cover. In another aspect of the invention, the illumination assembly includes a substrate, a mounting bracket and an illumination member. In yet another aspect of the invention, the illumination member is a light emitting diode (LED). In another aspect of the invention, the LED is one of a white LED and a red-green-blue (RGB) LED.

Another embodiment of the invention to provide a gaming machine including, a housing, a game assembly, a machine handle assembly including a handle mechanism having a base assembly, a cover assembly, a torsion assembly and a switch assembly, and a handle, wherein the machine handle assembly is mounted on the exterior of the housing. In an aspect of the invention, the machine handle assembly further includes an illumination assembly. In another aspect of the invention, the gaming machine is a slot machine.

Yet another embodiment of the invention to provide a method of assembling a gaming machine including the steps of: assembling a game assembly, wherein at least a portion of the game assembly is within a housing; assembling a machine handle assembly including a handle mechanism having a base assembly, a cover assembly, a torsion assembly, a switch assembly and a handle; and attaching the machine handle assembly to an exterior surface of the housing. In an aspect of the invention, the machine handle assembly further includes an illumination assembly. In another aspect of the invention, the gaming machine is a slot machine.

### BRIEF DESCRIPTION OF THE DRAWINGS

FIG. 1 is an exploded perspective view of an embodiment of a machine handle assembly;

FIG. 2 is a perspective view of the machine handle assembly of FIG. 1;

FIG. 3 is another perspective view of the machine handle assembly of FIG. 1;

FIG. 4 is a front elevation view of the machine handle assembly of FIG. 1;

FIG. 5 is a rear view of the machine handle assembly of FIG. 1;

FIG. 6 is a top plan view of the machine handle assembly of FIG. 1;

FIG. 7 is a bottom view of the machine handle assembly of FIG. 1;

FIG. 8 is a perspective view of another embodiment of a machine handle assembly; and

FIG. 9 is a perspective view of an embodiment of a gaming machine. FIG. 9 is a perspective view of an embodiment of a gaming machine.

FIG. 10 is a perspective view of a prior art handle on a gaming machine.

### DETAILED DESCRIPTION OF THE PREFERRED EMBODIMENTS

Detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

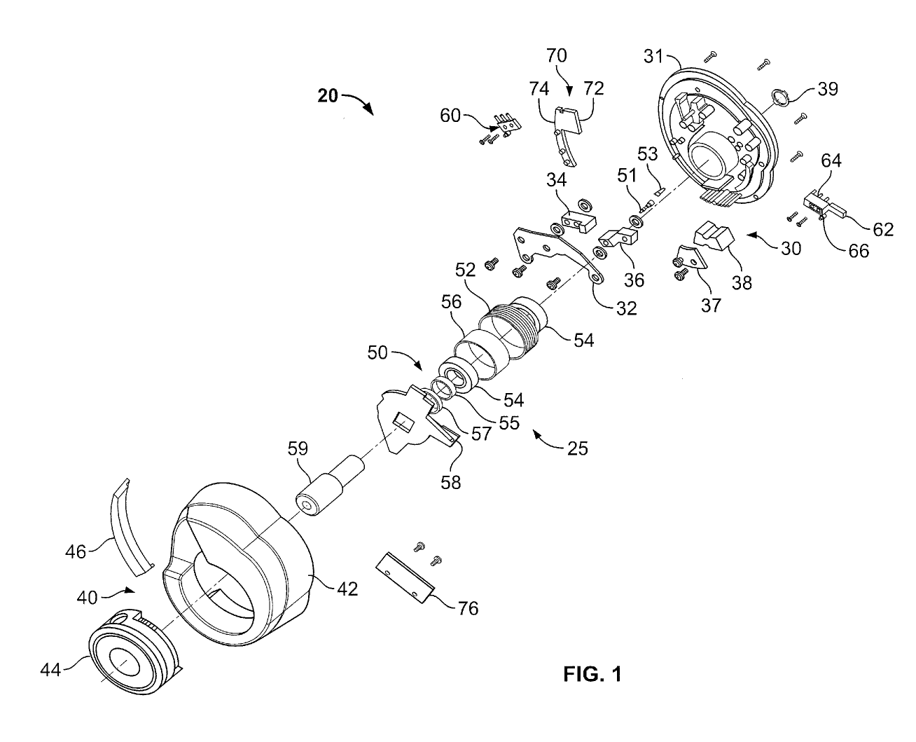

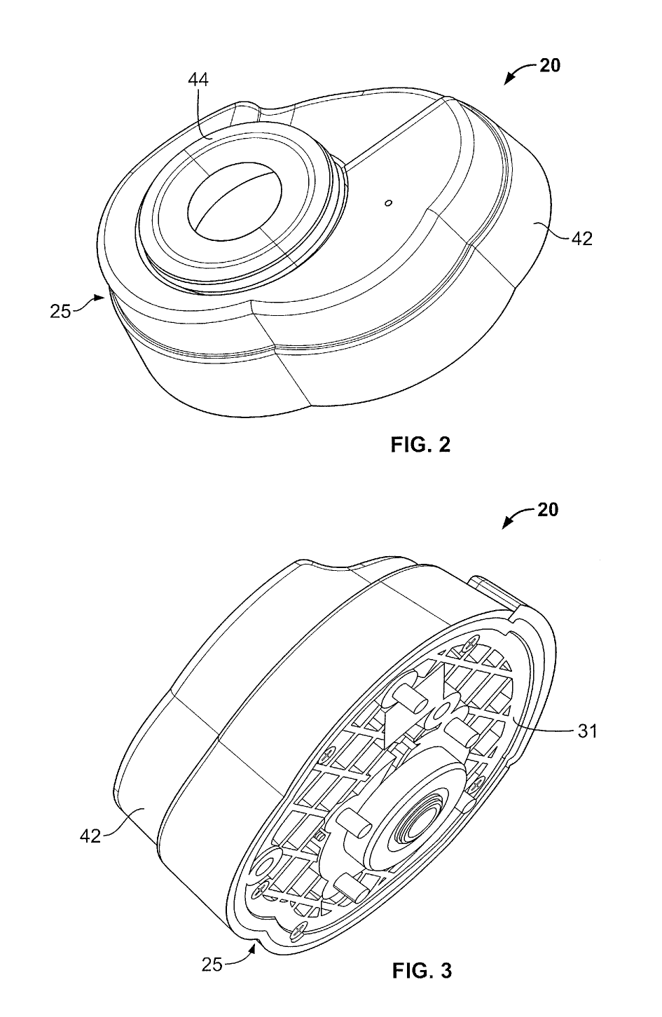

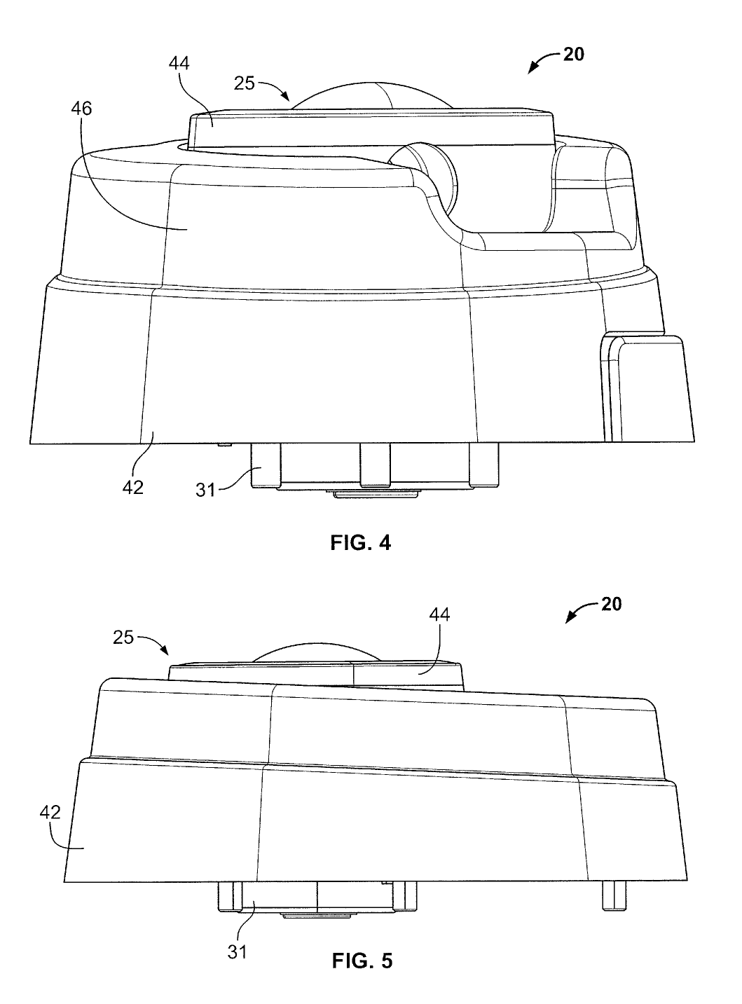

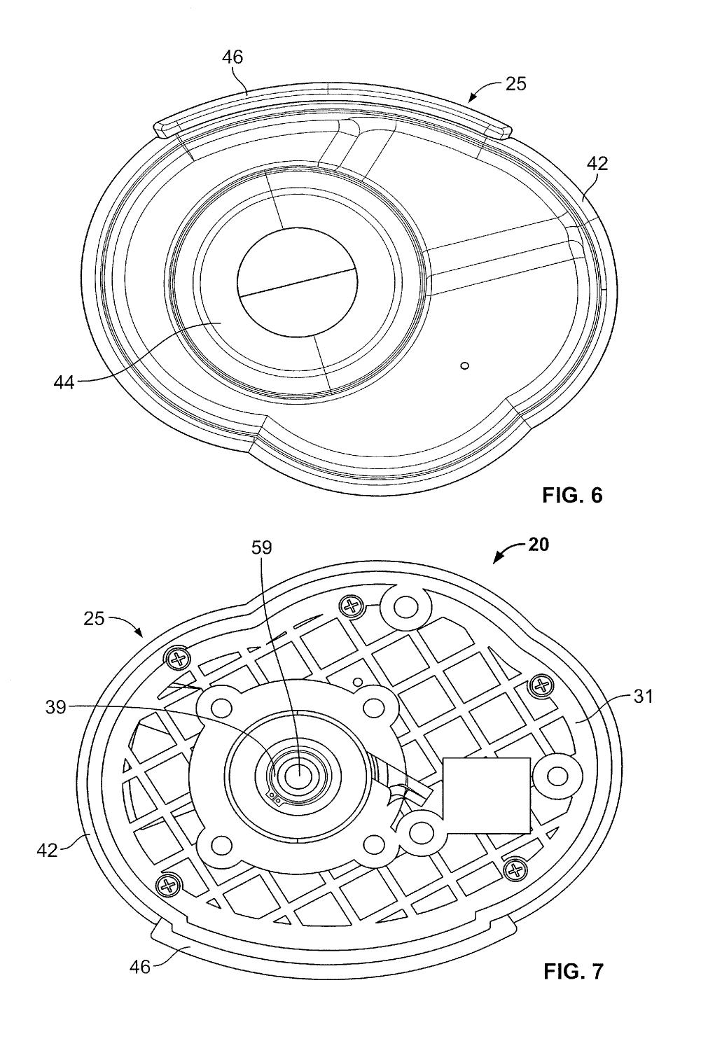

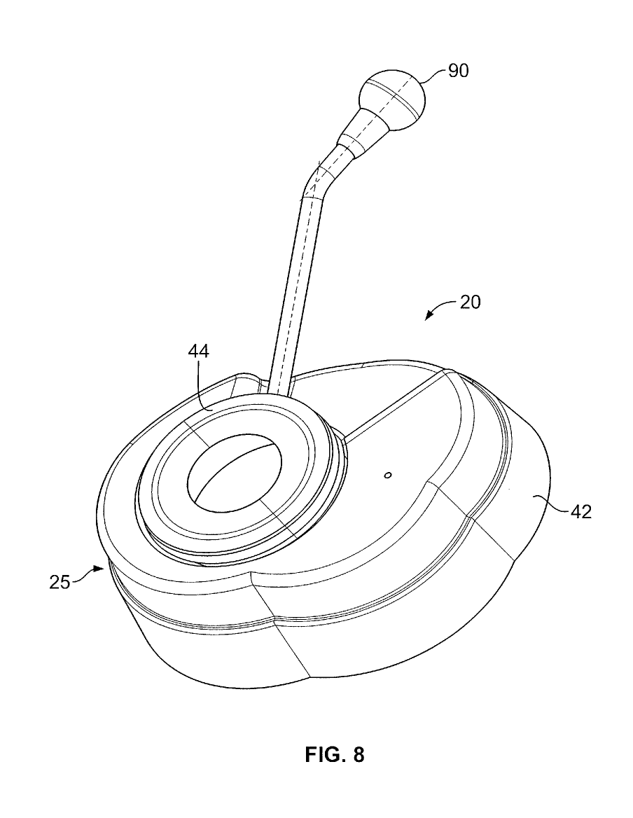

FIGS. 1-7 represent an embodiment of a machine handle assembly, generally designated as 20. Illustrated machine handle assembly 20 includes a handle mechanism 25. Handle mechanism 25 includes a base assembly 30, a cover assembly 40, a torsion assembly 50, a switch assembly 60 and an illumination assembly 70. As seen in FIG. 1, base assembly 30 includes a base 31. Base 31 may be formed of any industry standard material such as metal, plastic or a composite, for example. The illustrated base 31 is a cast metal. Base assembly 30 also includes a support bracket 32, a lock pin 34, a ratchet pin 36, a bumper bracket 37, a bumper 38 and a retaining member 39. Support bracket 32, lock pin 34, ratchet pin 36, bumper bracket 37, bumper 38 and retaining member 39 may be formed of any industry standard material such as metal, plastic or a composite, for example. The illustrated bumper 38 is made of urethane and the illustrated retaining member 39 is made of steel.

Cover assembly 40 includes a base cover 42, a center cover 44 and an illumination member cover 46. Alternatively, cover assembly 40 could be a single integrated cover or it could include a base cover and a center cover without an illumination member cover, for example. Base cover 42, center cover 44 and illumination member cover 46 may be formed of any industry standard material such as metal, plastic or a composite, for example. Illumination member cover 46 may be transparent, translucent, colored or have graphic designs to create various illumination effects, for example, or combinations of these.

Torsion assembly 50 includes a spring post 51, a spring 52, a spring pawl 53, a bearing 54, a bearing spacer 55, a spring collar 56, a spacer 57, a stop plate 58 and a shaft 59. Spring post 51, spring 52, spring pawl 53, bearing 54, bearing spacer 55, spring collar 56, spacer 57, stop plate 58 and shaft 59 may each be formed of any industry standard material such as metal, plastic or a composite, for example.

As seen in FIG. 1, one or more switch assemblies 60 are connected to base 31. Switch assembly 60 may be attached by the use of any industry standard attachment method, such as latches, snap tabs, adhesive or screws, for example. Illustrated switch assembly 60 is secured with screws. Switch assembly 60 may be any industry standard or custom switch that may include a switch housing 62, switch contacts 64 and an activation member 66 for engaging and disengaging with switch contacts 64, for example. The engaging and disengaging of switch contacts 64 allows a device to be turned on and off or a signal to be sent, for example. For example, switch assembly 60 may turn a light on and off, increment or decrement a counter, or provide positioning information of a handle.

Illumination assembly 70 includes a substrate 72, an illumination member 74 and a mounting bracket 76. Substrate 72 may be formed of any industry standard substrate such as a printed circuit board (PCB), for example. Illumination member 74 may be any industry standard form of lighting, such as incandescent bulbs, LEDs, or halogen bulbs, for example. The illustrated illumination member 74 is one of a white LED or an RGB LED. Alternatively, illumination assembly 70 could have multiple illumination members 74 of any type. For example, illumination assembly 70 could include a mixture of white and RGB LEDs or a combination of incandescent bulbs and LEDs.

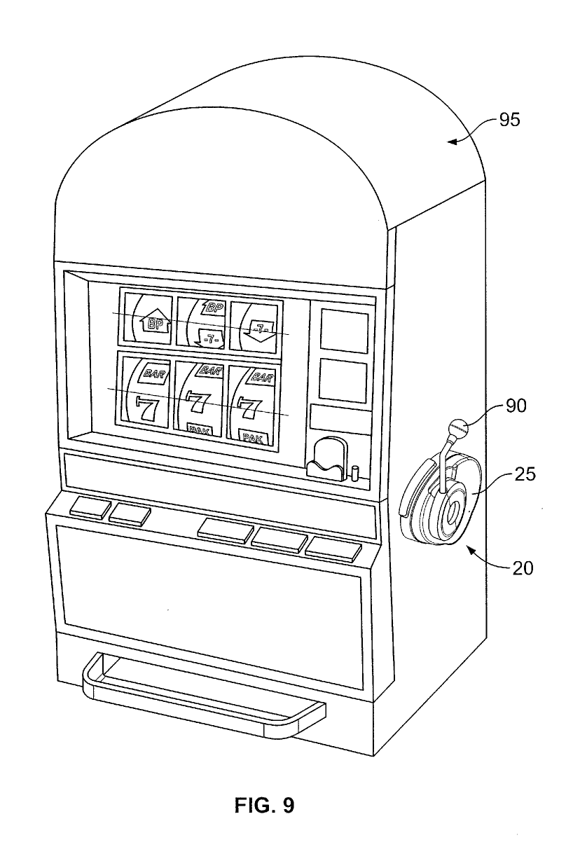

As seen in FIG. 8, another embodiment of the machine handle assembly 20 further includes a handle 90. Handle 90 may be any industry standard or custom design that properly engages with handle mechanism 25. Handle 90 provides a way for a user to control an aspect of a machine. For example, handle 90 can be a pull handle of a slot machine in which the user pulls handle 90 to cause a round of slot machine play to commence. Handle 90 can be a single integrated piece, a non-illuminated assembly or an illuminated assembly, for example. Handle 90 engages with torsion assembly 50 such that movement of handle 90 is translated to elements of handle mechanism 25. For example, spring 52 can act to bias handle 90 back to a specific position after being released by the user.

As seen in FIG. 9, machine handle assembly 20 is part of a machine 95. Machine 95 can be any type of machine allowing user interaction such as a manufacturing machine or a gaming machine, for example. The illustrated machine 95 is a slot machine for gaming. Handle 90, when operated, moves the previously described components contained within mechanism 25. Machine handle assembly 20 is attached to an exterior surface of machine 95, without requiring any components of machine handle assembly 20 to be inside machine 95. Also, there is no requirement to have access space within machine 95 in order to mount or attach machine handle assembly 20. Therefore, no space within machine 95 is required by machine handle assembly 20, which either frees up space within machine 95 to be used for other elements or functions, or allows machine 95 to be smaller or more compact.

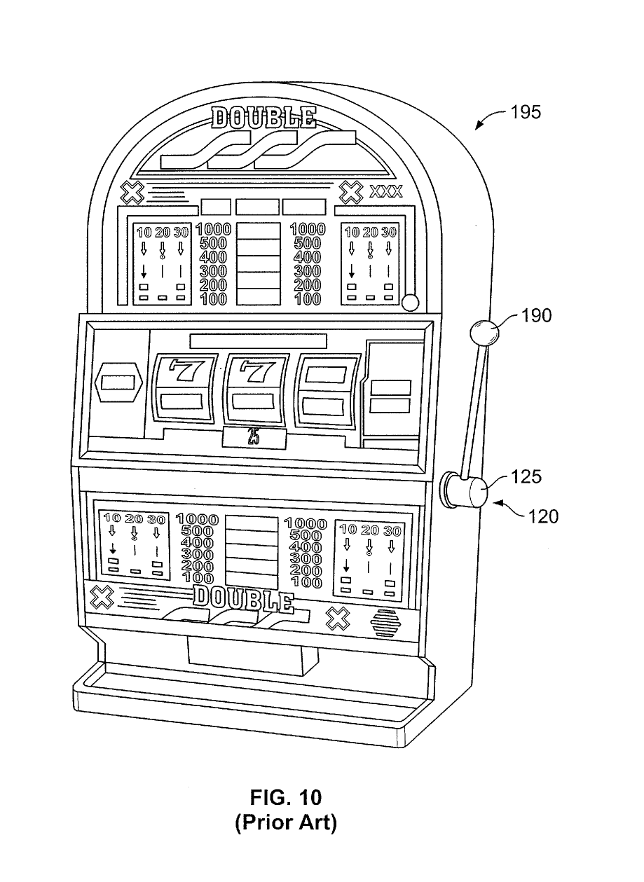

By comparison, FIG. 10 shows a typical prior art handle mechanism. Prior art machine handle assembly 120 is mounted to the wall of machine 195. Machine handle assembly 120 is essentially only a pivoting hub 125 projecting from the exterior surface or wall of machine 195, with operative components inside machine 195. Hub 125 is rotated by movement of handle 190.

Machine handle assembly 20 may be completely assembled separately from the manufacture and/or assembly of machine 95. This allows machine handle assembly 20 to be manufactured, stored and distributed as a completely separate component, providing increased flexibility and lower costs for both manufacturing and servicing machine 95. Machine handle assembly 20 can be removed or replaced without having to open machine 95, allowing for easy repairs, upgrades or reconfigurations of machine 95.

It will be understood that there are numerous modifications of the illustrated embodiments described above which will be readily apparent to one skilled in the art, such as variations and modifications of the machine handle assembly and/or its components including combinations of features disclosed herein that are individually disclosed or claimed herein, explicitly including additional combinations of such features, or alternatively other types of machine handle assemblies. For example, machine handle assemblies can have engagement mechanisms other than a spring based torsion assembly, such as an elastic band assembly or a proximity sensor assembly. Further, machine handle assemblies may be provided without an illumination assembly. Also, there are many possible variations in the materials and configurations. These modifications and/or combinations fall within the art to which this invention relates and are intended to be within the scope of the claims, which follow.

1. A machine handle assembly, comprising:
a handle mechanism, comprising:
a base assembly;
a cover assembly;
a torsion assembly;
a switch assembly; and
wherein the machine handle assembly is adapted to mount on the exterior of a machine.

2. The machine handle assembly of claim 1, further comprising a handle.

3. The machine handle assembly of claim 1, further comprising an illumination assembly;

4. The machine handle assembly of claim 1, wherein the torsion assembly comprises:
a shaft;
a bearing;
a spring;
a stop plate;
a spring collar;
a spacer;
a bearing spacer;
a spring post; and
a spring pawl.

5. The machine handle assembly of claim 1, wherein the base assembly comprises:
a base;
a support bracket;
a lock pin;
a ratchet pin;
a bumper bracket;
a bumper; and
a retaining member.

6. The machine handle assembly of claim 1, wherein the cover assembly comprises:
a base cover;
a center cover; and
an illumination member cover.

7. The machine handle assembly of claim 3, wherein the illumination assembly comprises:
a substrate;
a mounting bracket; and
an illumination member.

8. The machine handle assembly of claim 7, wherein the illumination member is a light emitting diode (LED).

9. The machine handle assembly of claim 8, wherein the LED is one of a white LED and a red-green-blue (RGB) LED.

10. A gaming machine, comprising:
a housing;
a game assembly;
a machine handle assembly, comprising:
a handle mechanism, comprising:
a base assembly;
a cover assembly;
a torsion assembly;
a switch assembly; and
a handle; and
wherein the machine handle assembly is mounted on the exterior of the housing.

11. The gaming machine of claim 10, wherein the machine handle assembly further comprises an illumination assembly.

12. The gaming machine of claim 10, wherein the gaming machine is a slot machine.

13. A method of assembling a gaming machine, comprising the steps of:
assembling a game assembly, wherein at least a portion of the game assembly is within a housing;
assembling a machine handle assembly, comprising:
a handle mechanism, comprising:
a base assembly;
a cover assembly;
a torsion assembly;
a switch assembly; and
a handle; and
attaching the machine handle assembly to an exterior surface of the housing.

14. The machine handle assembly method of claim 13, wherein the machine handle assembly further comprises an illumination assembly.

15. The machine handle assembly method of claim 13, wherein the gaming machine is a slot machine.
